(19) United States
(12) Patent Application Publication
(10) Pub. No.: US 2008/0154655 A1
(43) Pub. Date: Jun. 26, 2008

(54) Systems, Methods, and Computer Program Products for Retrieving Predicted Weather Conditions Corresponding to Selected Travel Itineraries Stored in an Inventory System

(75) Inventors: Josh Hartmann, Brooklyn, NY (US); Jeffrey Glueck, New York, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: TRAVELOCITY.COM LP

(21) Appl. No.: 11/931,394

(22) Filed: Oct. 31, 2007

Related U.S. Application Data
(60) Provisional application No. 60/863,669, filed on Oct. 31, 2006.

(51) Int. Cl. G06Q 10/00; G06Q 20/00

(52) U.S. Cl. 705/5; 705/27

(57) ABSTRACT

A system, method, and computer program product are provided for retrieving and displaying predicted weather conditions corresponding to travel destinations selected from an inventory system based on a user query. Some embodiments of the present invention further allow users to specify predicted weather conditions as criteria for searching for product options, such as travel itineraries in an inventory system. Some embodiments allow users to select and/or purchase a weather guarantee wherein at least a portion of a product option purchase price is refunded or credited to the user when actual weather conditions do not meet certain criteria for predicted weather conditions corresponding to the selected product option.

### CROSS REFERENCE TO RELATED APPLICATION

This application claims the benefit of U.S. Provisional Application No. 60/863,669, filed Oct. 31, 2006, the contents of which are incorporated herein in their entirety.

### BACKGROUND OF THE INVENTION

1. Field of the Invention.

The present invention relates to the field of computerized inventory systems, such as airline reservations systems or other product and/or service reservation or inventory systems, which are used to determine availability and pricing for products and/or services, such as travel itineraries. More particularly, the systems, methods, and computer program products of the present invention relate to improving the information content retrieved from an inventory system in response to user queries by using weather predictions at a selected travel destination to modify the user queries and by displaying weather predictions at selected travel destinations.

2. Description of Related Art.

Many of today's products and services, including travel and recreational itineraries, are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline tickets, hotel reservations, car rentals, event tickets, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, and AXESS.

Consumer interaction with these systems has evolved in recent years. Initially, these systems were difficult to use and did not always provide the best solution to a consumer's query. For example, in the early stages, a consumer interested in booking airline tickets would input a desired flight itinerary with desired travel dates and times and possible selected class of travel. The CRS system would check availability for the dates and return with a fare price meeting the specific input dates and times requested. Although there were some algorithms in place to aid the consumer in finding the lowest-priced fare, these algorithms were typically geared more toward providing quick results with less computing time and resources than in finding the lowest priced fare. For example, some early product availability and booking algorithms used a method that would heuristically select a subset of itineraries from a larger pool of itineraries, price this subset, and select the lowest-priced fare from the subset for display to the consumer. While these early systems provided timely results and reduced processing load on the CRS, they did not always provide the best solution to the consumer.

In light of this, the assignees of the present application developed an algorithm, (sometimes referred to as extended implicit enumeration algorithm), that could be used to efficiently determine the lowest fare for a particular flight itinerary. The algorithm used a k-shortest path schema that identified the lowest available fare that met a consumer's request and displayed this fare to the consumer. This algorithm is described more fully in U.S. Patent Application Ser. No. 09/421,895, filed on Oct. 21, 1999, entitled Method and Apparatus for Searching for a Low Fare for Travel Between Two Locations, and published as a PCT application under Publication No. WO 01/29693; the contents of which are incorporated herein.

The extended implicit enumeration algorithm was a major step forward in efficiently determining the lowest fare price for a given travel itinerary; it does have a few slight drawbacks. Specifically, the algorithm was designed to provide a small number of low priced answers with minimal consideration of diversity. The consumer inputs a request, and the algorithm returns only the lowest fare meeting the request. Unfortunately, such a process may not provide the best solution to a consumer or may miss an opportunity to market different fares to a customer that may maximize profits for the supplier, while also meeting the consumer's goals. Thus the assignee of the present invention developed a system, method, and computer program product to provide a plurality of low fare prices and different flight itinerary options for a given departure and return date combination, thereby allowing a user to view these different options and make a determination as to which fare and flight itinerary meets their goals as described more fully in U.S. Provisional Patent Application Ser. No. 60/573,546, filed on May 21, 2004, entitled, Systems, Methods, and Computer Program Products for Searching and Displaying Low Cost Product Availability Information for a Given Departure-Return Date Combination or Range of Departure-Return Date Combinations; the contents of which are also incorporated herein.

While conventional searching systems for low cost products may provide a user with a multitude of different product options including, in some cases, the lowest possible price for a given product option at the time of the search, conventional searching systems do not allow a user to simultaneously view predicted weather conditions for “last minute” booking of travel or recreational product options. This technical problem is especially apparent in conventional systems for searching for travel itinerary product options, wherein weather information corresponding to product options returned is not available as part of the search process. Thus, in some existing internet search environments, a user is forced to open multiple search windows, one corresponding to the product option search (using, for example, a conventional search system), and another corresponding to a weather forecasting service or website. The user must then manually change the destination inputs in the weather forecasting search to correspond to a particular product option (i.e. a travel destination) returned by the conventional searching system.

In addition, conventional searching systems do not have the capability of displaying product options (such as particular travel itineraries to a selected destination) corresponding to a weather condition selected by a user. For example, when searching for a last-minute weekend travel itinerary, a user may be most interested in a travel destination where the predicted weather conditions are warm and sunny. Using conventional searching systems, the user would be required to search not only for available travel products, but also separately search for predicted weather conditions corresponding to the various available destinations as a selected price point. Such redundant searches may create a burden on both a user's personal computer as well as various host computing elements configured to house a conventional searching system and/or a weather prediction service.

Therefore, there exists a need for an improved system to solve the technical problems outlined above that are associated with conventional search systems. More particularly, there exists a need for a system capable of receiving a search request including a selected weather condition and/or a selected destination and automatically searching a product database for travel product options corresponding to the selected weather condition and/or the selected destination. There also exists a need for such a system that is capable of displaying to a user predicted weather conditions associated with each of a plurality of travel products retrieved from an inventory system in response to a user query.

### BRIEF SUMMARY OF THE INVENTION

The needs outlined above are met by the present invention which, in various embodiments, provides a system that overcomes many of the technical problems discussed above, as well other technical problems, with regard to the retrieval and display of predicted weather conditions corresponding to travel itineraries selected from a database. Specifically in one embodiment, the invention provides a system comprising an inventory system comprising a plurality of travel itineraries including a corresponding plurality of destinations, a weather prediction system comprising a database comprising predicted weather conditions for the plurality of destinations, and a host computing element in communication with the weather prediction and inventory systems. The host computing element runs queries on the inventory system for retrieving travel itineraries stored therein. Furthermore, the host computing element simultaneously runs queries on the weather prediction system for retrieving predicted weather conditions for the plurality of destinations. The system also comprises an interface in communication with the host computing system for providing queries from a user to the host computing system and for displaying results from the queries to the user. The queries include at least one of a selected travel itinerary and a selected weather condition. The host computing element also retrieves at least one of a predicted weather condition for a selected destination corresponding to the selected travel itinerary and a suggested destination corresponding to the predicted weather condition that is substantially similar to the selected weather condition. Furthermore, the host computing element provides at least one of the predicted weather condition and the suggested destination to the interface, so that the user may be informed of the predicted weather condition for the selected destination and/or a suggested destination corresponding to the predicted weather condition that is substantially similar to the selected weather condition.

In some embodiments, the host computing element may further comprise a data cache for storing travel itinerary information received from the inventory system. The data cache may also be configured to be capable of storing predicted and/or observed weather conditions received from the weather prediction system. Thus the host computing element may receive predicted weather conditions from the weather prediction system at pre-determined intervals and automatically store such predicted and/or observed weather conditions for a plurality of different destinations.

According to some additional embodiments, the system may further comprise an accounting system for collecting a purchase price from the user for the selected travel itinerary to the selected destination. In such embodiments, the host computing element may be configured to be capable of comparing the predicted weather condition at the selected destination to an observed weather condition at the selected destination during a time period between a beginning date and an ending date of the selected travel itinerary. In some embodiments, the accounting system may be in communication with the host computing element such that the accounting system is configured to be capable of issuing a credit for at least a portion of the purchase price to the user if the predicted weather condition differs substantially from the observed weather condition at the selected destination during the time period defined by the selected travel itinerary.

In some embodiments, the process of comparing the predicted weather condition at the selected destination to an observed weather condition at the selected destination may be designated as a purchase option associated with the selected travel itinerary. In such embodiments, the accounting system may charge a fee to the user for such a purchase option. According to some embodiments, the fee for the purchase option may be varied by the host computing element based on a series of different variables corresponding to the product option wherein the variables may include, but are not limited to: the purchase date of the selected travel itinerary; the beginning date of the selected travel itinerary; the ending date of the selected travel itinerary; the duration of the selected travel itinerary; the likelihood of encountering weather conditions different from predicted weather conditions; and the selected weather condition. For example, the purchase option fee may be increased if the time period between the purchase date and the beginning date is a relatively long duration (due the increased chance that the predicted weather condition will not be substantially similar to an observed weather condition during the time period of the selected travel itinerary).

Some embodiments of the present invention also provide a method and computer program product for retrieving and displaying predicted weather conditions corresponding to travel destinations selected from an inventory system based on a user query. In one embodiment, the method and computer program product comprises receiving the user query, wherein the user query comprises at least one of a selected travel itinerary (including a selected destination), and a selected weather condition. The method further comprises retrieving at least one of: a predicted weather condition from a weather prediction system for the selected destination; and a suggested destination from the inventory system corresponding to a predicted weather condition that is substantially similar to the selected weather condition. Furthermore, the method further comprises providing at least one of the predicted weather condition and the suggested destination to an interface, such that the user may be informed of at least one of the predicted weather condition for the selected destination and the suggested destination corresponding to the predicted weather condition that is substantially similar to the selected weather condition. Additional method and computer program products may further comprise steps that may include: storing travel itinerary information received from the inventory system in a data cache of the host computing element; and storing predicted and/or observed weather conditions received from the weather prediction system in a data cache of the host computing element.

Some method and computer program products of the present invention may further comprise steps for collecting a purchase price from the user for the selected travel itinerary to the to the selected destination, and comparing the predicted weather condition at the selected destination to an observed weather condition at the selected destination during a time period between a beginning date and an ending date of the selected travel itinerary. In some such method embodiments, the method and/or computer program product may further comprise issuing a credit for at least a portion of the purchase price to the user if the observed weather condition differs substantially from the predicted weather condition at the selected destination during the time period. According to some embodiments, the comparing step described herein may be designated as a purchase option associated with the selected travel itinerary. In such embodiments, the method and/or computer program product may further comprise charging a fee to the user for the purchase option. Furthermore, in some such method embodiments, the charging step described herein may further comprise varying the fee for the purchase option based on a variable that may include, but is not limited to: the purchase date of the selected travel itinerary; the beginning date of the selected travel itinerary; the ending date of the selected travel itinerary; and the selected weather condition.

According to various embodiments of the present invention the selected weather condition may include, but is not limited to: a minimum temperature between a beginning date and an ending date of the selected travel itinerary; a maximum temperature between the beginning date and the ending date of the selected travel itinerary; an absence or presence of significant precipitation, wind, cloud cover or sun between the beginning date and the ending date of the selected travel itinerary; and a daily high temperature differing from a home daily high temperature at a home location of the user by a selected difference. Furthermore, the selected destination may comprise a variety of different travel destinations and/or recreational locations that may include, but are not limited to: an airport nearest a travel destination; a golf course; a coastal fishing area; a national park; and a recreational area. Moreover, the selected destination may be either static or dynamic (e.g., moving).

Thus the systems, methods, and computer program products for retrieving and displaying predicted weather conditions corresponding to travel itineraries selected from a database based on a search request, as described in the embodiments of the present invention, provide many advantages that may include, but are not limited to: expediting user searches for product options based on predicted weather conditions by presenting predicted weather conditions corresponding to various product options selected from a database simultaneously with a listing of the product options; relieving usage overloads in the product database and in a user interface by automatically consolidating predicted weather information with information related to a listing of product options (such as travel itineraries); providing a search system that allows a user to search for product options corresponding to a selected predicted weather condition such that the user may “search by weather” for a travel destination or recreational activity; and providing a search system that allows a user to purchase a “weather-guaranteed” product option that is capable or refunding at least part of a product option purchase price to the user in cases where the predicted weather condition varies substantially from an observed weather condition. The various system, method, and computer program embodiments of the present invention may be ideally suited for efficiently identifying product options (such as travel itineraries) having destinations with desirable predicted weather conditions (such as sunny and/or warm weather) such that a user may search “by weather” for a last-minute getaway vacation.

These advantages and others that will be evident to those skilled in the art are provided in the system, method, and computer program product of the present invention.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIGS. 1A and 1B illustrate a system for retrieving predicted weather conditions corresponding to selected travel itineraries according to one embodiment of the present invention.

FIG. 2 is a flow chart illustrating the steps performed according to one embodiment of the method of present invention.

FIG. 3 is a flow chart illustrating the steps performed according to one embodiment of the method of present invention, including the steps of collecting a purchase price from a user and refunding at least a portion of the purchase price if the predicted weather condition differs substantially from an observed weather condition at the selected destination.

FIG. 4 is a flow chart illustrating the steps performed according to one embodiment of the method of present invention including the steps of storing travel itineraries and predicted weather conditions in a data cache such that the host computer need only retrieve travel itineraries and predicted weather conditions at a predetermined interval.

FIG. 5 is an exemplary query page in the form of a web page illustrating the selection of at least one of a selected travel itinerary and a selected weather condition.

FIG. 6 is an exemplary results page in the form of a web page illustrating several travel itineraries offered to the user in response to a user query comprising a selected weather condition.

FIG. 7 is an exemplary results page in the form of a web page illustrating a selected travel itinerary corresponding to selected predicted weather condition as well as an offer to the user to purchase “guaranteed weather” protection corresponding to the purchase of the selected itinerary.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. While the systems, methods, and computer program products of the present invention are described in an airline ticket reservation environment, it should be understood that this is only one non-limiting example of the possible use of the embodiments of the present invention. More specifically, the system, method, and computer program product embodiments of the present invention may be adapted to any number of products and services and are not limited to the retrieval and display of predicted weather conditions at a destination airport of a low-cost travel itinerary. For example, the present invention may be used to search by, retrieve, and display predicted weather conditions at a variety of locations (corresponding to various product options). Such locations may include, but are not limited to: rail itinerary destinations; cruise line destinations; hotel locations; resort locations; sporting event venues; beaches; and other recreational areas.

It is also noted here that the term customer and user may both used herein. These terms are for the most part used interchangeably. User may sometimes be used to refer to individuals or entities that maintain the system, as opposed to individuals or entities that purchase product. Further, the terms “departure dates” and “return dates” are used herein as specific to embodiments in which the product option is an airline ticket or a particular travel ticket itinerary. It is understood that other products with which the present invention is used may use the terms “start date of use” and “length of use.” For example, if the product is a hotel room, the start date would be the day the customer arrives, and the customer would stay for a number of nights representing a length of stay, as opposed to use of a return date.

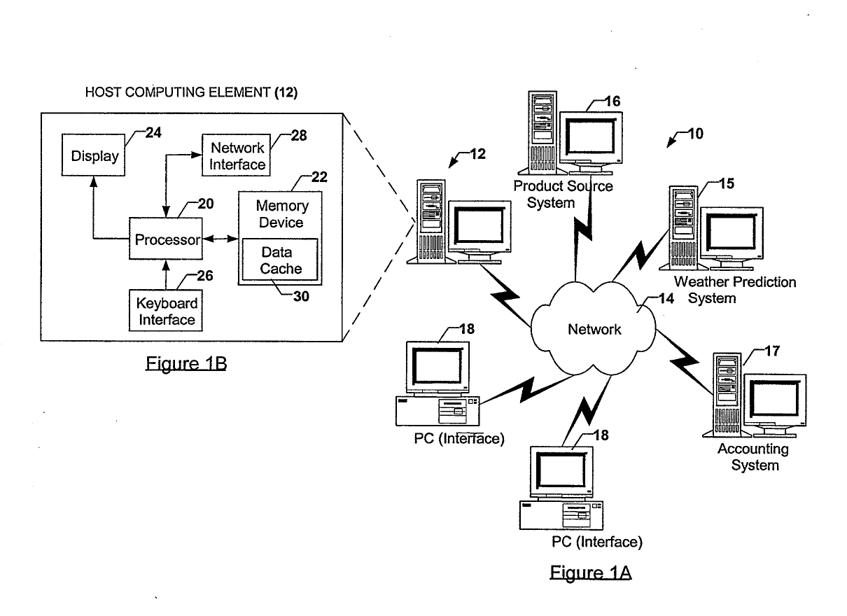

FIGS. 1A and 1B illustrate an example of a system 10 for retrieving and displaying predicted weather conditions (from a weather prediction system 15, for example) corresponding to travel itineraries selected from a database (such as a product source system 16 or reservation system). The system 10 includes a host computer 12 that operates a web site or other similar customer interface. The host computer 12 is typically connected to a network 14, such as a LAN, WAN, Intranet, or Internet, for example.

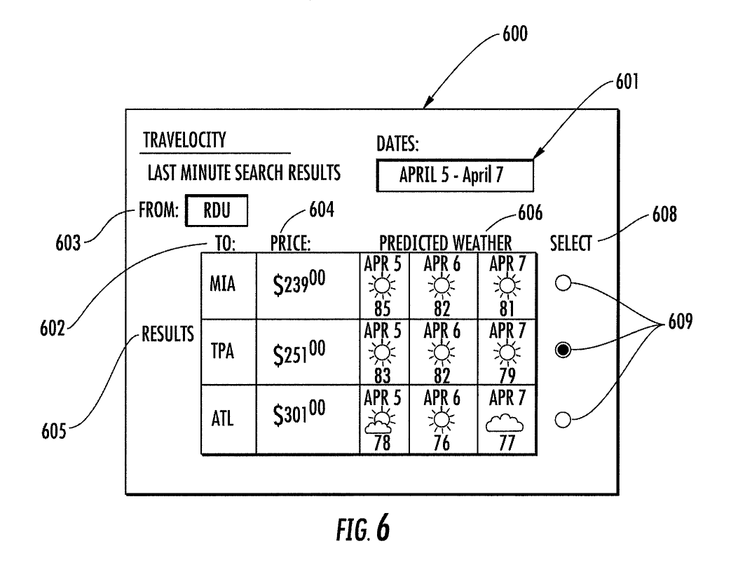

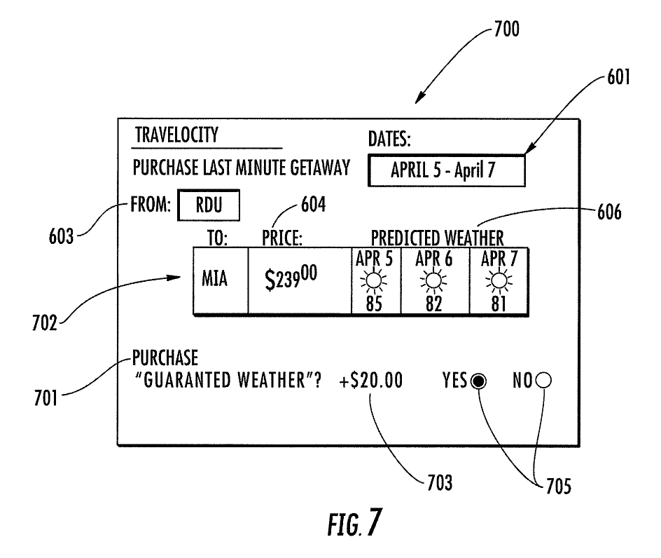

Also connected to the network 14 are various product source systems 16 (such as reservation systems, for example) for different products sources, such as hoteliers, airlines, car rental companies, etc. The product source systems 16 may also comprise, for example, computerized reservation systems (CRS) for airline ticket sales, electronic ticketing systems for recreational activities, sporting events, arts and entertainment events, rental cars, cruise reservations, rail travel reservations, bus travel reservations, recreational equipment rentals, and/or other types of product source systems 16. The product source system 16 (such as a product inventory system) comprises a plurality of travel itineraries (see, for example, the travel itinerary summarized in the purchase display 700 shown in FIG. 7) including a corresponding plurality of destinations 602 (see FIG. 6, for example).

Also connected to the network 14 are one or more weather prediction systems 15 comprising corresponding databases comprising predicted weather conditions for a plurality of destinations and/or geographic locations. The weather prediction systems 15 may also comprise various electronic sources for weather information such as, for example, government weather prediction services (such as, for example, the United States National Weather Service), commercial weather prediction systems (and websites hosted thereby), university and/or research weather prediction systems. Furthermore, as described in further detail herein, the weather prediction systems 15 may be configured to be capable of providing predicted weather conditions for a plurality of destinations, but also observed and/or historical weather conditions for the plurality of destinations.

Further, customers are also connected to the network via interfaces 18, such as personal computers or other types of computing systems. In addition, accounting systems 17 for receiving payments from users for product options selected for purchase (from the product source systems 16, for example) are also in communication with the network 14. The accounting system 17 may be housed in a computer device and in communication with the system 10 via the network 14 as shown in FIG. 1B. In other embodiments, the accounting system 17 may be housed in the processing element 20 of the host computer 12, described in further detail herein.

While the host computer 12, accounting system 17, product source system 16, weather prediction system 15, and user interfaces 18 are shown as separate systems, one skilled in the art will appreciate that some or all of the system 10 components may all be part of a common computing system.

The host computer 12 is in communication with the weather prediction system 15 and the product source system 16 for correlating predicted weather conditions 606 with each of the plurality of destinations 602 (as shown in the results display 600 generated by the host computer 12, shown in FIG. 6). As illustrated in exploded FIG. 1B, the host computer 12 is generally embodied as a typical computer, server or mainframe system, depending on the embodiment. The host computer 12 generally includes a processing element 20, such as a microprocessor, VLSI, ASIC, etc., a storage device 22, display 24, keyboard and mouse interface 26, and a network interface 28 configured to allow the host computer 12 to communicate with the network 14 of the system 10 of the present invention.

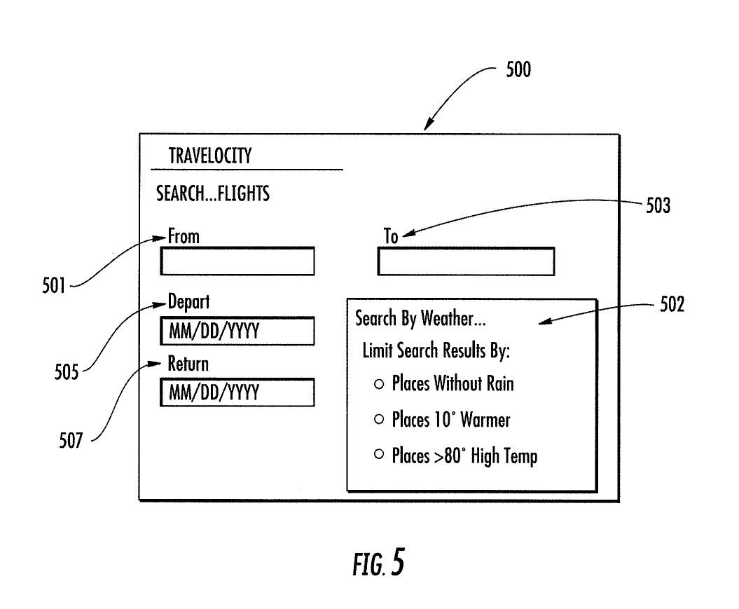

As described in further detail herein with respect to FIG. 6, the host computer 12 may also present a results display 600 in response to a user query that lists a plurality of suggested destinations 602 having predicted weather conditions 606 corresponding to, for example, a weather selection 502 input by a user as part of a user query. Because the host computer 12 is in communication with both the weather prediction system 15 and the product source system 16, a user need only access the host computer 12 (via a web page or other input display 500 (see FIG. 5)) in order to search by predicted weather conditions and/or be advised of predicted weather conditions 606 at a particular selected destination 702 during an upcoming time period. The host computer 12 is also configured to be capable of running queries on the product source system 16 for retrieving travel products (such as travel itineraries and their corresponding prices, for example) stored in the product source system 16 and for running queries on the weather prediction system 15 for retrieving predicted weather conditions 606 for the plurality of destinations 602 associated with the travel products retrieved from the product source system 16. As shown herein, the host computer 12 may also be capable of sorting the results display 600 by price 604 such that a user may evaluate a purchase decision based on a combination of price 604 and predicted weather conditions 606 during the dates 601 of a selected itinerary.

In some embodiments, the host computer 12 (and the product availability and search system housed therein) interrogates (in a pull configuration) the various product source systems 16 for product availability information and the various weather prediction systems 15 for predicted weather conditions 606 each time a consumer enters a request via the interface 18. However, in some embodiments, such frequent availability requests can slow down or disrupt the product source systems 16. Further, accessing the product source systems 16 and/or weather prediction systems 15 may have an associated processing delay. For this reason, in some embodiments, the host computer 12 may further include a prepopulated data cache 30 from which product availability and predicted weather condition information is derived for customer requests. Specifically, as shown in FIG. 1B, the host computer 12 of the present invention includes an availability cache 30 located, for example, in the memory device 22. The availability cache 30 is populated with various product availability information and predicted weather condition information needed to properly respond to user queries issued by customers.

As described herein, the system 10 of various embodiments of the present invention further comprises an interface 18, in communication with the host computer 12, for providing queries, including at least one of a selected travel itinerary and a selected weather condition, from a user to the host computer 12 and for displaying results from the queries to the user. The interface 18 (such as a user's personal computer in communication with the network 14) may be capable of receiving various user inputs (such as keystrokes, mouse clicks, or other inputs that will be appreciated by those skilled in the art) from a user to populate, for example, the user input display 500 generated by the host computer 12.

As shown in FIG. 5, the host computer 12 (via an interface 18 and/or via a display 24 included as part of the host computer 12) may be capable of generating a user input display 500 (in the form of a web page, for example) comprising various input windows for providing a query to the host computer 12 (and, in turn, to the product source system 16 and to the weather prediction system 15). The input display 500 may comprise, for example, a selected travel itinerary (comprising at least one of: a user departure location 501, a selected destination 503, and departure and return dates 505, 507). The input display 500 may also comprise, for example, a weather selection 502 (corresponding to a selected weather condition) such that a user may input a selected weather condition for limiting and/or defining the travel product search parameters. In some queries where, for example, the user's travel plans are flexible and wherein the user seeks to travel to a destination having a particular predicted weather condition relative to the weather at the departure location 501, the user need only input a selected departure location 501 and a weather selection 502 during a time period defined by departure and return dates 505, 507. In some such queries, the weather selection 502 may comprise a search for product options (such as travel itineraries) that will send the user to a destination (over the course of an upcoming weekend, for example) having a predicted daytime high temperature that is 25 degrees warmer than the corresponding predicted daytime high temperature of the selected departure location 501. Other weather selections 502 may limit the user query to retrieve travel products to suggested destinations 602 where the predicted weather conditions 606 include clear skies and calm conditions.

As shown in FIG. 5, the weather selection 502 portion of the input display 500 may comprise a plurality of check boxes corresponding to several selected predicted weather conditions. In other embodiments, the weather selection 502 portion of the input display 500 may comprise a drop down menu listing of predicted weather conditions for a plurality of selected destinations. Furthermore, in some embodiments, the weather selection 502 portion may also comprise a plurality of dialog boxes wherein the user may input a query comprising their “perfect weather” for an upcoming travel itinerary or outdoor activity. For example, the weather selection 502 portion of the input display 500 may comprise various inputs for the entry of a variety of predicted weather and weather-related conditions at selected destinations. Such conditions may include, but are not limited to: temperature; cloud cover; visibility; humidity; predicted snowfall; predicted rain; pollen count; high and low tide times; sunrise and sunset times; predicted marine conditions (such as wave height, offshore winds, and currents); and other predicted weather conditions. The weather selection 502 may also be defined not only by the predicted weather conditions, but also by the user departure location 501, a selected destination 503, and departure and return dates 505, 507. Thus, in some embodiments, the weather selection 502 may also comprise at least one of: a minimum temperature between a beginning date 505 and an ending date 507 of the selected travel itinerary; a maximum temperature between the beginning date 505 and the ending date 507 of the selected travel itinerary; an absence or presence of significant precipitation, wind, cloud cover or expected sun between the beginning date 505 and the ending date 507 of the selected travel itinerary; and a daily high temperature differing from a home daily high temperature at a home location (such as the user departure location 501) of the user by a selected difference.

In response to the user query (as defined, for example, by a user input display 500 such as that shown generally in FIG. 5), the host computer 12 retrieves (from the product source system 16 and weather prediction system 15, for example) at least one of a predicted weather condition for a selected destination corresponding to the selected travel itinerary and a suggested destination corresponding to the predicted weather condition that is substantially similar to the selected weather condition. According to various embodiments, the selected destination may comprise, for example, an airport nearest a travel destination; a golf course; a coastal fishing area; a national park; and a recreational area. Furthermore, the host computer 12 provides at least one of the predicted weather condition and the suggested destination to the interface 18 (in the form of a web page, for example, or other results display 600 as described further herein) such that the user may be informed of at least one of the predicted weather condition for the selected destination and the suggested destination corresponding to the predicted weather condition that is substantially similar to the selected weather condition.

For example, as shown in FIG. 6, in response to the user query, the host computer 12 (via an interface 18 and/or a display 24 included in the host computer 12) may be capable of generating a results display 600 (in the form of a web page, for example) for displaying a plurality of suggested destinations 602 having predicted weather conditions (during the selected travel dates) that are substantially similar to the selected weather condition (as input by a user, for example, in the weather selection 502 portion of the input display 500). The results display 600 may also comprise a listing of predicted weather conditions 606 for the suggested destinations 602 such that the user may be informed of precise day-to-day predicted weather conditions 606 at the suggested destination 602 over the course of the travel itinerary (as defined by the departure and return dates 505, 507). For example, in some embodiments, the results display 600 may include predicted weather conditions 606 that may include, but are not limited to: predicted daily high temperatures, predicted daily low temperatures, predicted humidity, predicted winds, predicted barometric pressure, predicted precipitation, and combinations of such weather conditions.

Furthermore, the results display 600 may also include a summary of the user's departure location 603 and departure and return dates 505, 507 (as shown in the travel dates window 601 of FIG. 6, for example). The results 605 listed in the results display 600 may also comprise a listing of price 604 for a travel product option corresponding to the suggested destination 502. The price 604 listing may include, but is not limited to: airfare costs, hotel rates, car rental rates at the suggested destination 602, recreational activity costs (such as golf greens fees, for example) and combinations thereof. The results display 600 may also comprise a selection tool 608 (including, for example, a plurality of check boxes 609) such that a user may select one of the suggested destinations 602 displayed in response to the user query (defined by, for example, the user inputs received in the user input display 500 (see FIG. 5). For example, as shown in FIG. 6, the results display 600 may comprise a listing of results 605 including several suggested destinations 602 (such as Miami, Tampa, and Atlanta), corresponding price 604 listings, and predicted weather conditions 606 matching, for example, a weather selection 502 of a user.

As described herein with respect to FIG. 1A, the system 10 may also comprise an accounting system 17 for collecting a purchase price (as shown in the price listings 604 of the results display 600) from the user for the selected travel itinerary to the to the selected destination. For example, as shown in the results display 600 of FIG. 6, some system 10 embodiments of the present invention may allow a user to select (via a plurality of check boxes 609) a selected destination 702 (as shown in the purchase display 700 of FIG. 7) from the listing of suggested destinations 602 displayed by the host computer 12 in the results display 600. The host computer 12 (in communication with the accounting system 17 and/or an interface 18) may then generate a purchase display 700 (as shown, for example, in FIG. 7) that summarizes the purchase price 604 of the product option corresponding to the selected destination 702.

Furthermore, in some such embodiments, the host computer 12 may compare the predicted weather condition 606 at the selected destination to an observed weather condition at the selected destination 702 during a time period between a beginning date and an ending date 505, 507 of the selected travel itinerary (as summarized in the purchase display 700). For example, in some embodiments, the host computer 12 may store the selected travel itinerary (including the selected destination 702, travel dates 601, and the predicted and/or observed weather 606 at the selected destination 702) in a data cache 30 within a memory device 22 in communication with and/or integrated with the host computer 12. During the travel dates 601, the host computer 12 may then monitor the weather prediction system 15 to retrieve and/or receive observed weather conditions at the selected destination 702 (via “push” and/or “pull” data transfer techniques as described further herein).

In other system 10 embodiments, the accounting system 17 may be in communication with the host computer 12 (via the network 14, for example) such that the accounting system 17 is further configured to be capable of issuing a credit for at least a portion of the purchase price 604 to the user if the predicted weather condition 606 differs substantially from the observed weather condition at the selected destination 702 during the time period between the beginning date 505 and the ending date 507 of the selected travel itinerary (as summarized, for example, in the purchase display 700 of FIG. 7). According to some system 10 embodiments, the host computer 12 may be accessible by an administrator and/or operator of the system 10 for adjusting various threshold values defining the differences between the predicted weather condition 606 and the observed weather condition (as reported by the weather prediction system 15, for example) that may act to trigger the issuance of a credit to the user by the accounting system 17 and/or host computer 12. For example, a temperature difference of greater than 5 degrees between a predicted daily high temperature and an observed daily high temperature may be defined as a threshold at which the credit is issued to the user. Thus, system 10 embodiments of the present invention may enable the host computer 12 and accounting system 17 to provide a “weather guarantee” to users who purchase a selected itinerary (as defined, for example, by the purchase display 700) based at least in part on a weather selection 502 (as shown, for example in the user input display 500 of FIG. 5).

In some additional embodiments, the process of comparing the predicted weather condition 606 at the selected destination 702 to an observed weather condition at the selected destination 702 is designated as a purchase option (see, for example, the purchase option graphic 701 shown in the purchase display 700 of FIG. 7) associated with the selected travel itinerary. Furthermore, in some embodiments, the accounting system 17 may be configured to be capable of charging a fee to the user for the purchase option. For example, as shown in FIG. 7, the purchase display 700 generated by the host computer 12 may include a purchase option graphic 701 (comprising, for example, yes/no check boxes 703, 705) for offering a “guaranteed weather” option to a user for a specified fee (such as the twenty dollar fee shown in the purchase option graphic 701 of FIG. 7). Upon selecting the purchase option (by selecting the “yes” check box 703 of the purchase display 700, for example, a user may then be assured that the system 10 of the present invention (via an accounting system 17, for example) will refund at least a portion of the purchase price 604 for the selected itinerary (as summarized in the purchase display 700) if the observed weather conditions at the selected destination 702 differ substantially from the predicted weather conditions 606 outlined for the selected destination 702 in the purchase display 700. The host computer 12 and/or accounting system 17 may be configured to be capable of varying the fee charged for the “guaranteed weather” based on a variety of factors that may include, but are not limited to: the purchase date of the selected travel itinerary; the beginning date 505 of the selected travel itinerary; the ending date 507 of the selected travel itinerary; the duration of the selected travel itinerary; the likelihood of encountering weather conditions different from predicted weather conditions (e.g., based on other heuristics or the destination); and the selected weather condition (as defined by the weather selection 502 received by the host computer 12 via the user input display 500, for example).

In some embodiments, the selection of the purchase option (via the selection of the “yes” check box 703, for example) may also direct the host computer 12 to store the travel itinerary information received from the product source system 16 and the predicted weather conditions 606 received from the weather prediction system 15 (as summarized in the purchase display 700). Thus, the host computer 12 may access the stored weather conditions 606 corresponding to a particular user's travel itinerary to determine if the predicted weather conditions 606 differ from the observed weather conditions at the selected destination 702 by a sufficient margin to trigger the automatic refund of at least a portion of the purchase price 604 in accordance with the “weather guarantee” purchased by the user. As described herein, the host computer 12 may be capable of accessing the weather prediction systems 15 to receive observed and/or historical weather conditions for a plurality of destinations and/or geographical locations corresponding to the selected destination 702. The host computer 12 may also be configured to be capable of storing (in an integrated memory device 30, for example) the observed weather conditions received from the weather prediction systems 15 in order to document the observed weather conditions at the selected destination 702 during the travel dates 601 in case a dispute arises with a user as to whether the purchased “weather guarantee” warrants the issuance of at least a partial refund of the purchase price 604 of the travel product.

According to various embodiments of the present invention, the system 10 may monitor (via push and/or pull mechanisms) multiple product source systems 16, weather prediction systems 15, and/or reservation systems with which the operators of the system 10 may or may not have a pre-existing commercial relationship. For example, the system 10 may be configured to be capable of monitoring a number of different product source systems 16 and/or weather prediction systems 17 having a direct commercial relationship with the system 10 of the present invention, as well as other product source systems 16 that may be generally or publicly accessible via a network 14.

The above description describes a pull mode, whereby the system 10 periodically interrogates the product sources systems 16 and/or weather prediction systems 15 for suggested travel itineraries and other travel products, corresponding pricing, and predicted weather conditions for selected destinations. In other embodiments, however, the system 10 may operate in a push mode, whereby the product source systems 16 and weather prediction systems 15 send information to the host computer 12 (and/or a processing element 20 thereof) when there has a been a change in the status of a travel product (including, for example, a change in predicted weather condition at a corresponding destination and/or a change in the pricing of the travel product). The operation of such a “push” mode is described in U.S. patent application Ser. No. 09/276,825, filed Mar. 26, 1999, entitled Event Based System for Distributing Travel Information, and assigned to the assignee of the present application. The system may also use both push and pull technologies together to receive travel product information (including information on suggested destinations 602 corresponding to weather selections 502 defined by a user query (as shown, for example, in the user input display 500 of FIG. 5).

The various embodiments of the present invention may be adapted to analyze any portion of a sales transaction for changes in the transaction (such as the predicted weather condition) from the time of purchase to time of use or delivery of the product. For example, embodiments of the present invention may analyze predicted weather conditions corresponding to a selected travel itinerary to identify changes in the predicted weather conditions between the time of purchase and time of use or delivery. For example, the product may include travel to a selected destination (selected, for example, on the basis of sunny and clear predicted weather conditions at the destination) purchased one week in advance. In some instances, the predicted weather condition at the destination may change to cloudy or rainy conditions, while a second product including travel to a second destination (with predicted sunny and clear weather conditions) may remain available for a similar price. Embodiments of the present invention would offer the purchaser the second product (corresponding to travel to the second destination) in order to better comply with the purchaser's selected predicted weather condition. The item could be a golf outing at a first golf course selected at the time of purchase based on predicted warm conditions with calm winds, but prior to the tee time the predicted weather condition changes to rain and high winds. The system would then offer a booking or change in reservations to the user for a second golf course predicted to experience the selected warm and calm weather conditions at the selected date and tee time.

Furthermore, the various embodiments discussed herein generally discuss that a substantial difference between an observed weather condition and a predicted weather condition automatically triggers a credit or refund to be applied to the customer. In some embodiments, the various embodiments of the present invention may offer a change in selected destination (to a second destination having the selected predicted weather conditions) to the customer for review and in exchange for the original travel product.

For example, if the original travel product is a hotel package purchased with the understanding that weather at the selected destination (i.e. the hotel location) would include daytime high temperatures of at least 80 degrees, but later (and before the departure date) the predicted high temperature at the hotel drops to 70 degrees, the system may offer to the user a change in reservation to a second hotel (corresponding to a nearby or completely different destination, for example) having a predicted weather condition substantially equivalent to the selected weather condition. The system 10 of the present invention may also be capable of periodically updating a user with regard to changes in the predicted weather conditions related to a selected product via website (accessible to users via interfaces 18 in communication with a network 14 as generally described herein). In other embodiments, the user may be periodically informed of changes in predicted weather conditions corresponding to a selected product via personal email, automated phone call, or other notification method of the day-to-day predicted weather changes associated with a selected product option. The user may also be provided with information via a web site page that indicates changes in product price that may be associated with revising the reservation to a second product option corresponding to more favorable predicted weather conditions.

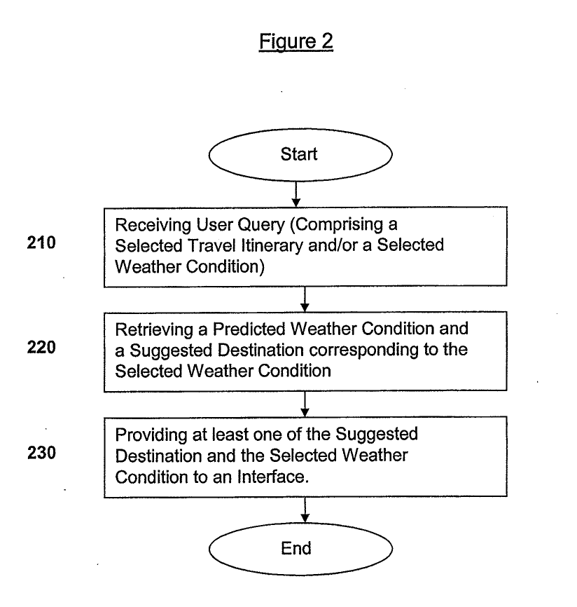

The present invention also includes various method embodiments for retrieving and displaying predicted weather conditions 606 corresponding to travel destinations (see element 602 of FIG. 6, for example) selected from an inventory system based on a user query in a manner that reduces the burden on inventory systems. As shown in the exemplary flow chart of FIG. 2, the method comprises step 210 for receiving the user query, wherein the user query comprises at least one of a selected travel itinerary, including a selected destination, and a selected weather condition.

For example, as shown in FIG. 5, the host computer 12 described herein may be capable of generating a user input display 500 for receiving the user query which may comprise, for example, a selected travel itinerary (defined by a user departure location 501, a selected destination 503, and departure and return dates 505, 507). The user query defined by the input display 500 may also comprise, for example, a weather selection 502 for limiting and/or defining the travel product search parameters. The selected destination 503 may include a variety of geographical locations that may include, but are not limited to: an airport nearest a travel destination; a golf course; a coastal fishing area; a national park; a recreational area; and other selected destinations. The selected destination could be a static destination (e.g., a city, point of interest, or other fixed location) or a dynamic destination (e.g., a moving location such as a cruise ship, driving tour, etc.). For a dynamic destination provided weather information may provide information useful in, for example, sequencing waypoints or determining a forward or reverse order for sequential waypoints. Furthermore, the weather selection 502 (including, for example, a selected weather condition) may include, but is not limited to: a minimum temperature between a beginning date 505 and an ending date 507 of the selected travel itinerary; a maximum temperature between the beginning date 505 and the ending date 507 of the selected travel itinerary; an absence or presence of significant precipitation, wind, cloud cover, or expected sun between the beginning date 505 and the ending date 507 of the selected travel itinerary; a daily high temperature differing from a home daily high temperature at a departure location 501 of the user by a selected difference.

The method also comprises step 220 for retrieving a predicted weather condition 606 from a weather prediction system 15 for the selected destination. Step 220 may also comprise retrieving one or more suggested destinations 602 from the inventory system (such as a product source system 16) corresponding to a predicted weather condition that is substantially similar to the selected weather condition (as defined by the weather selection 502 input via the user input display 500). As described herein, step 220 may be accomplished by the host computer 12 via a “pull” configuration wherein the host computer 12 interrogates at least one of the product source system 16 and the weather prediction system 15 to retrieve the one or more suggested destinations 602 from the inventory system and/or a predicted weather condition 606 from a weather prediction system 15 for the selected destination. In other embodiments, step 220 may also comprise periodically receiving (at the host computer 12, for example) updated data from at least one of the product source system 16 and the weather prediction system 15. For example, the product source system 16 and the weather prediction system 15 may be configured to be capable of periodically sending updated predicted weather conditions 606 and/or suggested destinations 602 (in a “push” mode) to the host computer 12. In such embodiments, step 220 may also comprise, storing the retrieved data (including, for example, predicted weather conditions 606 and/or suggested destinations 602) in a data cache 30 included as part of a memory device 22 in communication with the host computer 12.

The method further comprises step 230 for providing at least one of the predicted weather condition 606 and the suggested destinations 602 to an interface 18 (and/or a display 24 integrated with the host computer 12) such that the user may be informed of at least one of the predicted weather condition 606 for the selected destination 503 (as input by the user via the input display 500 of FIG. 5) and one or more suggested destinations 602 corresponding to the predicted weather condition 606 that is substantially similar to the weather selection 502 (which may also be input by the user via the input display 500 of FIG. 5). For example, step 230 may be performed by the host computer 12, which may be configured to be capable of generating a results display 600 (see FIG. 6) in the form of a computer graphic and/or web page that may be presented to the user in response to the user query (defined by the user input display 500, for example). Step 230 may further comprise transmitting the generated results display 600 to at least one of an interface 18 (such as a user's personal computer in communication with the host computer 12 via the network 14) and a display 24 included as part of the host computer 12. As shown in FIG. 6, the user display 600 generated by the host computer 12 according to some method embodiments in step 230 may include, but is not limited to: a listing of suggested destinations 602, a listing of travel product prices 604 corresponding to the suggested destinations 604, a listing of the predicted weather conditions 606 for each of the suggested destinations 602 during the travel dates 601. The results display 600 may further comprise a selection tool 608 (including, for example, a plurality of check boxes 609) such that a user may select one of the suggested destinations 602 displayed in response to the user query (defined by, for example, the user inputs received in the user input display 500 (see FIG. 5).

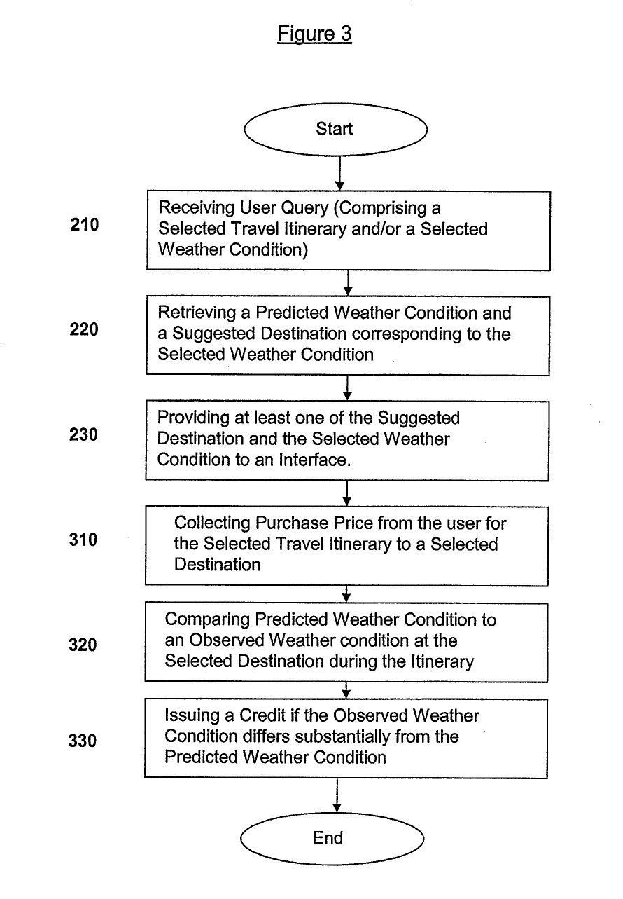

As shown in FIG. 3, various method embodiments of the present invention may further comprise step 310 for collecting a purchase price from the user for the selected travel itinerary to the to the selected destination. For example, as shown in FIG. 7, the host computer 12 may be capable of generating a purchase display 700 including a listing of a selected destination 702 (selected by a user from a listing of suggested destinations 602 as described herein with respect to FIG. 6), a price 604 corresponding to the selected destination 702, and a predicted weather condition 602 corresponding to the selected destination 702. In step 310, the host computer 12 may be capable of receiving payment from a user via credit card or other electronic payment methods that will be appreciated by one skilled in the art. The method may also further comprise, in step 320, comparing the predicted weather condition 606 at the selected destination 702 to an observed weather condition (as reported, for example, by a weather prediction system 15 in communication with the host computer 12) at the selected destination 702 during a time period 601 between a beginning date and an ending date of the selected travel itinerary. For example, the host computer 12 may perform step 320 by storing the predicted weather conditions 606 presented to the user in the results display 600 and/or the purchase display 700 in a memory device 30 included as part of the host computer 12.

Furthermore, the host computer 12 may monitor the weather prediction system 15 during the travel dates 601 corresponding to the predicted weather conditions 606 to retrieve and/or receive observed weather conditions at the selected destination 702. Finally, in step 320, the host computer 12 may also compare the stored predicted weather conditions 606 to the received observed weather conditions at the selected destination 702 during the travel dates 601.

As shown in FIG. 3, various method embodiments of the present invention may also comprise step 330 for issuing a credit for at least a portion of the purchase price 604 to the user if the observed weather condition (retrieved from the weather prediction system 15, for example) differs substantially from the predicted weather conditions 606 at the selected destination 702 during the time period defined by the travel dates 601. As shown in the purchase display 700 of FIG. 7, the comparing step 320 (and, if appropriate, the corresponding issuing step 330) may be designated as a purchase option 701 by the host computer 12. The purchase option 701 may be associated with the selected travel itinerary (which is indicative of a selected destination 702, for example).

In such embodiments, the method may further comprise charging a fee 702 to the user for the purchase option 701 wherein the method (via steps 320 and 330) provides a “weather guarantee” to the user in exchange for the fee 702. In method embodiments comprising charging a fee 702 for the “weather guarantee” implemented, for example, in method steps 320 and 330, the method may further comprise varying the fee 702 for the purchase option 701 based on the various parameters of the user query (as defined by the user input display 500, for example) that may include, but are not limited to: the purchase date of the selected travel itinerary; the beginning date 505 of the selected travel itinerary; the ending date 507 of the selected travel itinerary; and the weather selection 502.

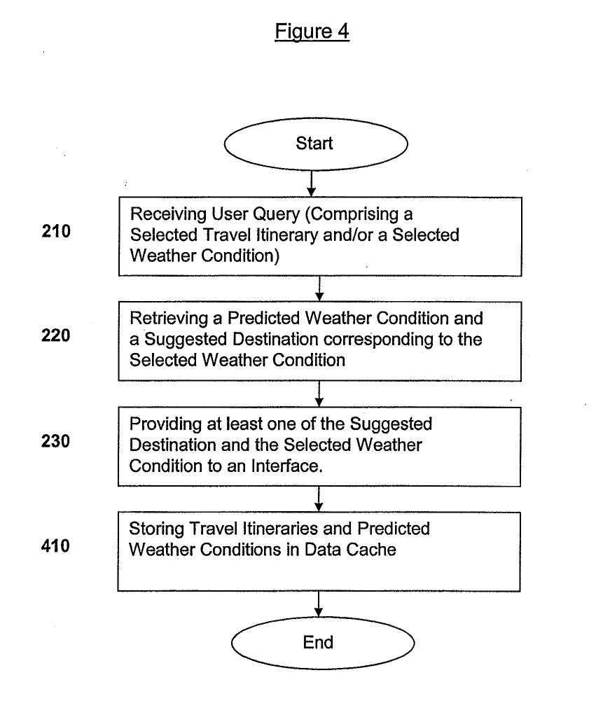

FIG. 4 shows another alternate method embodiment of the present invention further comprise step 410 for storing travel itinerary information (such as, for example, a plurality of suggested destinations 602, corresponding product option prices 604, user departure location 603, departure and return travel dates 505, 507) received from the product source system 16 (or other inventory system) in a data cache 22 of the host computer 12. Step 410 may also comprise storing predicted weather conditions 606 received from the weather prediction system 15 in a data cache 22 of the host computer 12. As described herein, frequent availability and predicted weather conditions 606 requests can slow down or disrupt the product source systems 16 and/or weather prediction systems 15. Further, repeatedly accessing the product source systems 16 and/or weather prediction systems 15 in response to each user query (defined by the user input display 500, for example) may have an associated processing delay. Thus, in some method embodiments, the storing step 410 may comprise prepopulating a data cache 30 from which product availability and predicted weather condition information may be derived in response to user requests. Specifically, as shown in FIG. 1B and described herein, the host computer 12 of the present invention may comprise an availability cache 30 located, for example, in the memory device 22. The availability cache 30 may be populated with various product availability information and predicted weather condition information needed to properly respond to user queries issued by customers such that the retrieving step 220 may be accomplished by the host computer 12 by simply accessing an internal memory device 30 and/or an alternative dedicated memory device or data cache in communication with the host computer 12 via the network. Furthermore, and as described further herein, the host computer 12 may obtain product availability and predicted weather condition information from various product source systems 16 and/or weather prediction systems 15 via “push” or “pull” protocols.

In addition to providing systems and methods, the present invention also provides computer program products for performing the operations described above. The computer program products have a computer readable storage medium having computer readable program code embodied in the medium. With reference to FIG. 1B, the computer readable storage medium may be part of the memory device 22, and may implement the computer readable program code to perform the above discussed operations.

In this regard, FIGS. 2-4 are block diagram, flowchart and control flow illustrations of methods, systems and program products according to exemplary embodiments of the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus are capable of implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instructions which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of steps for performing the specified functions, and program instructions for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for retrieving and displaying predicted weather conditions corresponding to travel itineraries selected from a database based on a search request, the system comprising:
an inventory system comprising a plurality of travel itineraries including a corresponding plurality of destinations;
a weather prediction system comprising a database comprising predicted weather conditions for the plurality of destinations;
a host computing element in communication with said weather prediction system and said inventory system for running queries on said inventory system for retrieving travel itineraries stored in said inventory system and for running queries on said weather prediction system for retrieving predicted weather conditions for the plurality of destinations;
an interface, in communication with said host computing system, for providing queries, including at least one of a selected travel itinerary and a selected weather condition, from a user to said host computing system and for displaying results from the queries to the user,
wherein said host computing element retrieves at least one of a predicted weather condition for a selected destination corresponding to the selected travel itinerary and a suggested destination corresponding to the predicted weather condition that is substantially similar to the selected weather condition; and
wherein said host computing element provides at least one of the predicted weather condition and the suggested destination to said interface, such that the user may be informed of at least one of the predicted weather condition for the selected destination and the suggested destination corresponding to the predicted weather condition that is substantially similar to the selected weather condition.

2. A system according to claim 1, further comprising an accounting system for collecting a purchase price from the user for the selected travel itinerary to the selected destination.

3. A system according to claim 1, wherein said host computing element compares the predicted weather condition at the selected destination to an observed weather condition at the selected destination during a time period between a beginning date and an ending date of the selected travel itinerary.

4. A system according to claim 3, wherein said accounting system is in communication with said host computing element and further issues a credit for at least a portion of the purchase price to the user if the predicted weather condition differs substantially from the observed weather condition at the selected destination during the time period between the beginning date and the ending date of the selected travel itinerary.

5. A system according to claim 1 wherein the selected weather condition is at least one of:
a minimum temperature between a beginning date and an ending date of the selected travel itinerary;
a maximum temperature between the beginning date and the ending date of the selected travel itinerary;
an absence or presence of significant precipitation between the beginning date and the ending date of the selected travel itinerary;
an absence or presence of wind between the beginning date and the ending date of the selected travel itinerary;
an absence or presence of cloud cover between the beginning date and the ending date of the selected travel itinerary;
an absence or presence of expected sun between the beginning date and the ending date of the selected travel itinerary; and
a daily high temperature differing from a home daily high temperature at a home location of the user by a selected difference.

6. A system according to claim 3, wherein the process of comparing the predicted weather condition at the selected destination to an observed weather condition at the selected destination is designated as a purchase option associated with the selected travel itinerary and wherein the accounting system charges a fee to the user for the purchase option.

7. A system according to claim 1, wherein the selected destination is capable of being selected from options including a static destination and a dynamic destination.

8. A system according to claim 1, wherein said host computing element comprises a data cache for storing travel itinerary information received from the inventory system and for storing predicted or observed weather conditions received from the weather prediction system.

9. A method for retrieving and displaying predicted weather conditions corresponding to travel destinations selected from an inventory system based on a user query in a manner that reduces the burden on inventory systems, the method comprising:
receiving the user query, the user query comprising at least one of a selected travel itinerary, including a selected destination, and a selected weather condition;
retrieving at least one of a predicted weather condition from a weather prediction system for the selected destination and a suggested destination from the inventory system corresponding to a predicted weather condition that is substantially similar to the selected weather condition;
providing at least one of the predicted weather condition and the suggested destination to an interface, such that the user may be informed of at least one of the predicted weather condition for the selected destination and the suggested destination corresponding to the predicted weather condition that is substantially similar to the selected weather condition.

10. A method according to claim 9, further comprising collecting a purchase price from the user for the selected travel itinerary to the to the selected destination.

11. A method according to claim 9, further comprising comparing the predicted weather condition at the selected destination to an observed weather condition at the selected destination during a time period between a beginning date and an ending date of the selected travel itinerary.

12. A method according to claim 11, further comprising issuing a credit for at least a portion of the purchase price to the user if the observed weather condition differs substantially from the predicted weather condition at the selected destination during the time period.

13. A method according to claim 9 wherein the selected weather condition is at least one of:
a minimum temperature between a beginning date and an ending date of the selected travel itinerary;
a maximum temperature between the beginning date and the ending date of the selected travel itinerary;
an absence or presence of significant precipitation between the beginning date and the ending date of the selected travel itinerary;
an absence or presence of wind between the beginning date and the ending date of the selected travel itinerary;
an absence or presence of cloud cover between the beginning date and the ending date of the selected travel itinerary;
an absence or presence of expected sun between the beginning date and the ending date of the selected travel itinerary; or
a daily high temperature differing from a home daily high temperature at a home location of the user by a selected difference.

14. A method according to claim 9 wherein the selected destination is capable of being selected from options including a static destination and a dynamic destination.

15. A method according to claim 11, wherein the process of comparing the predicted weather condition at the selected destination to an observed weather condition at the selected destination is designated as a purchase option associated with the selected travel itinerary and further comprising charging a fee to the user for the purchase option.

16. A method according to claim 15, wherein the charging step further comprises varying the fee for the purchase option based on at least one of:
the purchase date of the selected travel itinerary;
the beginning date of the selected travel itinerary;
the ending date of the selected travel itinerary;
the duration of the selected travel itinerary;
the likelihood of encountering weather conditions different from predicted weather conditions; and
the selected weather condition.

17. A method according to claim 9, further comprising:
storing travel itinerary information received from the inventory system in a data cache of the host computing element; and
storing predicted weather conditions received from the weather prediction system in a data cache of the host computing element.

18. A computer program product for retrieving and displaying predicted weather conditions corresponding to travel destinations selected from an inventory system based on a user query in a manner that reduces the burden on inventory systems, said computer program product comprising a computer-readable storage medium having computer-readable program code portions stored therein, the computer-readable program code portions comprising:
a first set of computer instructions for receiving the user query, the user query comprising at least one of a selected travel itinerary, including a selected destination, and a selected weather condition;
a second set of computer instructions for retrieving at least one of a predicted weather condition from a weather prediction system for the selected destination and a suggested destination from the inventory system corresponding to a predicted weather condition that is substantially similar to the selected weather condition; and
a third set of computer instructions for providing at least one of the predicted weather condition and the suggested destination to an interface, such that the user may be informed of at least one of the predicted weather condition for the selected destination and the suggested destination corresponding to the predicted weather condition that is substantially similar to the selected weather condition.

19. A computer program product according to claim 18, further comprising a fourth set of computer instructions for collecting a purchase price from the user for the selected travel itinerary to the to the selected destination.

20. A computer program product according to claim 18, further comprising a fifth set of computer instructions for comparing the predicted weather condition at the selected destination to an observed weather condition at the selected destination during a time period between a beginning date and an ending date of the selected travel itinerary.

21. A computer program product according to claim 20, further comprising a sixth set of computer instructions for issuing a credit for at least a portion of the purchase price to the user if the observed weather condition differs substantially from the predicted weather condition at the selected destination during the time period between the beginning date and the ending date of the selected travel itinerary.

22. A computer program product according to claim 18 wherein the selected weather condition is at least one of:
a minimum temperature between a beginning date and an ending date of the selected travel itinerary;
a maximum temperature between the beginning date and the ending date of the selected travel itinerary; an absence or presence of significant precipitation between the beginning date and the ending date of the selected travel itinerary;
an absence or presence of wind between the beginning date and the ending date of the selected travel itinerary;
an absence or presence of cloud cover between the beginning date and the ending date of the selected travel itinerary;
an absence or presence of expected sun between the beginning date and the ending date of the selected travel itinerary; or
a daily high temperature differing from a home daily high temperature at a home location of the user by a selected difference.

23. A computer program product according to claim 20, wherein the fifth set of computer instructions for comparing the predicted weather condition at the selected destination to an observed weather condition at the selected destination is designated as a purchase option associated with the selected travel itinerary and further comprising a seventh set of computer instructions for charging a fee to the user for the purchase option.

24. A computer program product according to claim 18, wherein the selected destination is capable of being selected from options including a static destination and a dynamic destination.

25. A computer program product according to claim 18, further comprising:
a ninth set of computer instructions for storing travel itinerary information received from the inventory system in a data cache of the host computing element; and
a tenth set of computer instructions for storing predicted weather conditions received from the weather prediction system in a data cache of the host computing element.
